(19) United States
(12) Patent Application Publication
(10) Pub. No.: US 2024/0397569 A1
(43) Pub. Date: Nov. 28, 2024

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/685,712

(22) PCT Filed: Aug. 24, 2021
(86) PCT No.: PCT/CN2021/114342

§ 371 Date: Feb. 22, 2024

(51) Int. Cl. H04W 76/15; H04W 52/02; H04W 76/40

(52) U.S. Cl. CPC H04W 76/15; H04W 52/0216; H04W 76/40

(57) ABSTRACT

A communication method, including: determining a first message frame in a first link among multi-links, the first message frame including first information on traffic indication map (TIM) frame broadcast intervals related to the multi-links and requested by a station, the multi-links referring to multi-links established between the station and an access point, associated with the station, supporting multi-link communication; and sending the first message frame.

### CROSS-REFERENCE TO RELATED APPLICATION

The present application is a U.S. National Stage of International Application No. PCT/CN2021/114342, filed on Aug. 24, 2021, the contents of all of which are incorporated herein by reference in their entirety for all purposes.

### BACKGROUND OF THE INVENTION

Current studies on Wi-Fi technology cover 320 MHz bandwidth transmission, multi-band aggregation and coordination etc. It is expected that there is at least four times increase in rate and throughput compared with existing standards. The Wi-Fi technology is mainly applied in scenarios of video transmission, augmented reality (AR), virtual reality (VR), etc.

The multi-band aggregation and coordination refers to communication between devices simultaneously at frequency bands of 2.4 GHz, 5 GHz, 6 GHz etc. A new media access control (MAC) mechanism needs to be defined to manage the communication between devices simultaneously at a plurality of frequency bands. In addition, it is also expected that the multi-band aggregation and coordination can support low-latency transmission.

The current multi-band aggregation and coordination technology can support a maximum bandwidth of 320 MHz (160 MHz+160 MHz), and can also support a bandwidth of 240 MHz (160 MHz+80 MHz) and other bandwidths.

In current technologies, a station (STA) and an access point (AP) may be multi-link devices (MLD), that is, support a function of transmission and/or reception in multi-links. In this case, in the current technologies, there may be multi-links between the STA and the AP, and the communication between the two devices in the multi-links is being studied.

### SUMMARY OF THE INVENTION

The present disclosure relates to the field of wireless communications, and in particular to a communication method and a communication apparatus.

According to an example of the present disclosure, there is provided a communication method. The communication method may be performed by a station supporting multi-link communication. The communication method includes: determining a first message frame in a first link among multi-links; and sending the first message frame. The first message frame includes first information on traffic indication map (TIM) frame broadcast intervals related to the multi-links and requested by the station. The multi-links refers to multi-links established between the station and an associated access point supporting the multi-link communication.

According to an example of the present disclosure, there is provided a communication method. The communication method may be performed by an access point supporting multi-link communication. The communication method includes: receiving a first message frame in a first link among multi-links; and performing a communication operation based on the first message frame. The first message frame includes first information on traffic indication map (TIM) frame broadcast intervals related to the multi-links and requested by a station, the station supporting the multi-link communication and associated with the access point. The multi-links refers to multi-links established between the station and the access point.

According to an example of the present disclosure, there is provided a communication apparatus. The communication apparatus may be applied to a station supporting multi-link communication. The communication apparatus includes: a processing module, configured to determine a first message frame in a first link among multi-links; and a transceiving module, configured to send the first message frame. The first message frame includes first information on traffic indication map (TIM) frame broadcast intervals related to the multi-links and requested by the station. The multi-links refers to multi-links established between the station and an associated access point supporting the multi-link communication.

According to an example of the present disclosure, there is provided a communication apparatus. The communication apparatus may be applied to an access point supporting multi-link communication. The communication apparatus includes: a transceiving module, configured to receive a first message frame in a first link among multi-links; and a processing module, configured to control execution of a communication operation based on the first message frame. The first message frame includes first information on traffic indication map (TIM) frame broadcast intervals related to the multi-links and requested by a station, the station supporting the multi-link communication and associated with the access point. The multi-links refers to multi-links established between the station and the access point.

According to an example of the present disclosure, there is provided an electronic device. The electronic device includes a memory, one or more processors, and a computer program stored in the memory and runnable on the one or more processors. The computer program, when executed by the one or more processors, causes the one or more processors to collectively implement the method described above.

According to an example of the present disclosure, there is provided a non-transitory computer-readable storage medium, storing a computer program. The computer program, when executed by one or more processors, causes the one or more processors to collectively implement the method described above.

### BRIEF DESCRIPTION OF DRAWINGS

The above and other features of the examples of the present disclosure will become more apparent from the detailed description of the examples of the present disclosure with reference to the accompanying drawings.

FIG. 1 is a diagram illustrating a communication scenario in multi-links.

FIG. 2 is a flowchart illustrating a communication method according to an example of the present disclosure.

FIG. 3 is a flowchart illustrating an interactive communication according to an example of the present disclosure.

FIG. 4 is a flowchart illustrating a communication method according to an example of the present disclosure.

FIG. 5 is a block diagram illustrating a communication apparatus according to an example of the present disclosure.

FIG. 6 is a block diagram illustrating an electronic device according to an example of the present disclosure.

### DETAILED DESCRIPTION OF THE INVENTION

The following descriptions with reference to the accompanying drawings are provided to aid in a full understanding of various examples of the present disclosure as defined by the appended claims and their equivalents. The various examples of the present disclosure include various details, but these details are considered to be illustrative. In addition, for the sake of clarity and conciseness, descriptions of well-known techniques, functions, and constructions may be omitted.

Terms and words used in the present disclosure are not limited to written meanings, but are used by the inventors to enable a clear and consistent understanding of the present disclosure. For those skilled in the art, the description of various examples of the present disclosure is provided for illustrative purposes and not for the purpose of limitation.

It is to be understood that, unless the context clearly stated otherwise, the singular forms “a/an”, “one”, “the” and “said” as used may also include a plural form. It needs to be further understood that the expression “include/comprise” used in the present disclosure refers to the presence of the described features, integers, steps, operations, elements and/or components, but cannot preclude the presence or addition of one or more other features, integers, steps, operations, elements, components and/or groups thereof.

It is to be understood that although the terms “first”, “second” and the like may be used to describe various elements, these elements should not be limited to these terms. These terms are used to distinguish one element from another. Without departing from the teachings of the examples of the present disclosure, a first element discussed below may be referred to as a second element.

It is to be understood that when an element is described as being “linked” or “coupled” to another element, the described element may be directly linked or coupled to the other element, or there may be an intermediate element between the described element and the other element. Moreover, the “linked” or “coupled” as used may include wireless link or wireless coupling. The term “and/or” or the expression “at least one of” as used includes any and all combinations of one or more related listed items.

All terms (including technical and scientific terms) as used have the same meanings as commonly understood by those of ordinary skilled in the art of the present disclosure, unless otherwise defined.

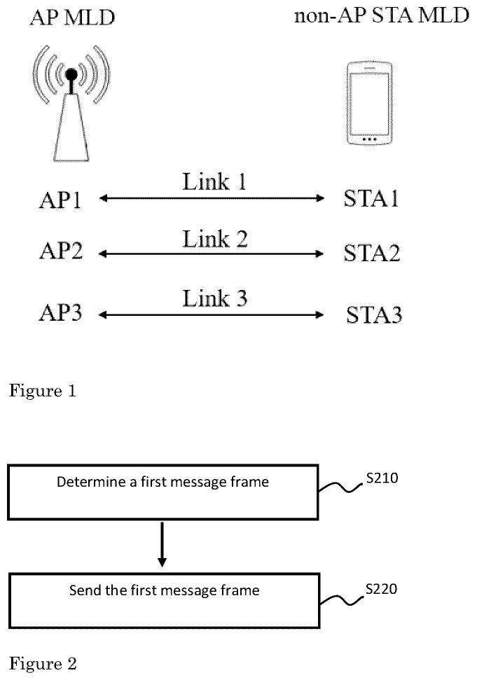

FIG. 1 is a diagram illustrating a communication scenario in multi-links.

In a wireless local area network, a basic service set (BSS) may include an AP and one or more STAs communicating with the AP. One BSS may be linked to a distribution system (DS) through its AP, and then linked to another BSS to form an extended service set (ESS).

The AP is a wireless switch used for a wireless network, and an access device for a wireless network. An AP may be used as a wireless base station, and may function as a bridge to link a wireless network with a wired network. With this type of AP, wired and wireless networks may be integrated.

The AP may include at least one of a software application or a circuit, to enable other types of nodes in the wireless network to communicate with the outside of the wireless network as well as the inside of the wireless network through the AP. In some examples, the AP may be a terminal or a network device equipped with a wireless fidelity (Wi-Fi) chip.

In an example, the STA may include, but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, etc.

In an example of the present disclosure, the AP and the STA may be devices supporting multi-links, for example, may be represented as AP MLD and non-AP STA MLD, respectively. For ease of description, an example in which one AP MLD communicates with one non-AP STA MLD in the multi-links (referred to as “multi-link communication”) is described in the following. However, the examples of the present disclosure are not limited to this. For example, one AP MLD may perform the multi-link communication with a plurality of non-AP STA MLDs respectively, or one non-AP STA MLD may perform the multi-link communication with different AP MLDs.

In FIG. 1, as an example, an AP MLD may represent an AP which supports a multi-link communication function, and a non-AP STA MLD may represent a STA which supports the multi-link communication function. Referring to FIG. 1, the AP MLD may work in three links, i.e., the AP MLD may include three secondary APs, that is, AP1, AP2 and AP3. The non-AP STA MLD may also work in three links, i.e., the non-AP STA MLD may include three secondary STAs, that is, STA1, STA2 and STA3 as shown in FIG. 1. In the example in FIG. 1, it is assumed that AP1 communicates with STA1 through a corresponding first link, that is, Link 1. Similarly, AP2 and AP3 communicate with STA2 and STA3 through a second link (Link 2) and a third link (Link 3), respectively. In addition, Link 1 to Link 3 may be multi-links at different frequencies, for example, links etc., at 2.4 GHz, 5 GHz, and 6 GHz or several links with the same or different bandwidths at 2.4 GHz, 5 GHz, and 6 GHz. In addition, a plurality of channels may exist in each link. The communication scenario shown in FIG. 1 is illustrative, and the present disclosure is not limited to this example. For example, the AP MLD may communicate with the non-AP STA MLD in more or fewer links; or the AP MLD may be linked to a plurality of non-AP STA MLDs; or in each link, the AP may communicate with a plurality of other types of STAs.

The AP MLD may send a traffic indication map (TIM) frame to identify a modification of a BSS parameter. For example, in a case that a critical update occurs to any element within a beacon frame, the AP MLD may increase a value (modulo 256) of a check beacon field in the next TIM frame to be sent. According to an example of the present disclosure, the following events regarding operation parameters of an AP will be classified as critical updates:
a) Inclusion of a Channel Switch Announcement element;
b) Inclusion of an Extended Channel Switch Announcement element;
c) Modification of the EDCA parameters element;
d) Inclusion of a Quiet element;
e) Modification of the DSSS Parameter Set;
f) Modification of the HT Operation element;
g) Inclusion of a Wide Bandwidth Channel Switch element;
h) Inclusion of a Channel Switch Wrapper element;
i) Inclusion of an Operating Mode Notification element;
j) Inclusion of a Quiet Channel element;
k) Modification of the VHT Operation element;
l) Modification of the HE Operation element;
m) Insertion of a Broadcast TWT element; and
n) Inclusion of the BSS Color Change Announcement element, etc.

In addition, it will be understood that these events are illustrative, and the examples of the present disclosure are not limited to these. Other system information events are also feasible, such as Modification of the EHT Operation element, Modification of the MU EDCA Parameter Set element, Modification of the Spatial Reuse Parameter Set element, Modification of the UORA Parameter Set element, etc.

However, there is a lack in the related art of a method of how to listen for TIM frames in multi-links. Specifically, existing mechanisms are only applicable to communication operations in a single link. However, for devices that support multi-link communication, the devices may listen for beacon frames or TIM frames in different links. In this case, it is needed to perform a negotiation (e.g., through a re-association/association) process in different links or to send a TIM broadcast request frame to perform negotiation. Therefore, the existing mechanisms need to be enhanced.

FIG. 2 is a flowchart illustrating a communication method according to an example of the present disclosure. The communication method as shown in FIG. 2 may be performed by a station (e.g., a non-AP STA MLD) supporting the multi-link communication, and includes steps S210 and S220.

Referring to FIG. 2, in step S210, a first message frame is determined in a first link among multi-links. According to an example of the present disclosure, the first message frame may include first information on traffic indication map (TIM) frame broadcast intervals related to the multi-links and requested by the station. In the examples of the present disclosure, the multi-links refers to multi-links established between the station and an associated access point supporting the multi-link communication. For example, in the example shown in FIG. 1, the multi-links may refer to Link1 to Link3, and the first link may be one of Link1 to Link3.

In the examples of the present disclosure, there may be many ways to determine the first message frame. For example, the first message frame may be generated according to at least one of the following conditions: network conditions, load conditions, hardware capabilities of a sending/receiving device, service types, and relevant protocol provisions, which are not limited in the examples of the present disclosure. In the examples of the present disclosure, the first message frame may also be acquired from an external device, which is not limited in the examples of the present disclosure.

According to an example of the present disclosure, the first message frame may be a re-association request frame, an association request frame, a TIM broadcast request frame, etc. However, the present disclosure is not limited to this, and other types of frames that may carry the first information are also feasible. In the examples of the present disclosure, the first information may include information on the TIM frame broadcast intervals related to the multi-links and requested by the station. In an example, the TIM frame is lightweight, i.e., merely carries information necessary to identify the presence of a change in a BSS parameter. For example, compared to a beacon frame which carries multi-link (ML) information elements, various capability information elements, etc., the TIM frame may merely carry information such as TIM information and check beacon information.

In an example of the present disclosure, the first information may include a set value of the TIM frame broadcast interval for the first link. The TIM frame broadcast interval may indicate a number of beacon frame cycles between sending of the TIM frames. The set value of the TIM frame broadcast interval for the first link may be based on the beacon frame cycles in the first link. For example, as described in conjunction with FIG. 1, in a case that the first link is Link2, in response to the set value of the TIM frame broadcast interval for the first link being n (n being an integer greater than or equal to 1), the TIM frame broadcast interval may refer to n cycles during which the beacon frame is transmitted in Link2, i.e., one TIM frame is transmitted over n such cycles. By requesting the TIM frame broadcast interval for the first link, the STA may listen for the TIM frames at regular time to determine for example whether the BSS parameter has changed. In this case, the first information may be at an MLD level. In other words, the first message frame merely carries the TIM frame broadcast interval related to one link (the first link) and does not carry TIM frame broadcast intervals related to other links among the multi-links. However, the TIM frame broadcast intervals related to other links may be determined according to the set value of the TIM frame broadcast interval for the first link. For example, a value of the TIM frame broadcast interval for another link other than the first link among the multi-links has a specific offset value from the set value of the TIM frame broadcast interval for the first link. The specific offset value may be carried in other information elements (e.g., a reduced neighbor report (RNRE) information element, and a multi-link (ML) information element) that are transmitted between a non-AP STA MLD and an AP MLD.

The first information may be encapsulated in the first message frame in various forms. In the following, for ease of description, the first information is described in the form of an information element. For example, the first information may be in the form of a TIM broadcast request element as shown in Table 1 below. Therefore, in the following, the first information and the TIM broadcast request information element can be used interchangeably.

TABLE 1
Format of TIM broadcast request information element

| | | |
|---|---|---|
| Element ID | Length | TIM Broadcast Interval |

Referring to Table 1, the Element ID field may be used to identify the TIM broadcast request information element, the Length field may indicate a length of the TIM broadcast request information element, and the TIM Broadcast Interval field may indicate the number of beacon frame cycles between sending of the TIM frames.

The value of the TIM Broadcast Interval field in Table 1 may be an example of the set value of the TIM frame broadcast interval for the first link as included in the first information. In the following, the TIM Broadcast Interval may be used interchangeably with the TIM frame broadcast interval.

For example, in one link, an STA attached to a non-AP STA MLD carries the TIM broadcast request information element during a multi-link establishment process (e.g., an association request frame). The set value of the TIM broadcast interval in the TIM broadcast request information element is based on the beacon frame cycles in this link.

In another example of the present disclosure, the first information may include the set value of the TIM frame broadcast interval for each of the multi-links. In this example, the first information may also include link ID information configured to identify each of the multi-links. In this case, the first information may be at a link level, that is, the first information may include set values of TIM frame broadcast intervals corresponding to the multi-links respectively. In a case that the first information is described by taking the TIM broadcast request information element as an example, the TIM broadcast request information element may have a format as shown in Table 2 below.

TABLE 2
Format of TIM broadcast request information element

| | | | | | | |
|---|---|---|---|---|---|---|
| Element | Length | TIM | Link | TIM | Link | . . . |
| ID | | Broadcast | ID 1 | Broadcast | ID 2 | |
| | | Interval 1 | | Interval 2 | | |

The Element ID field and the Length field in Table 2 are similar to that in Table 1. Repeated descriptions are omitted to avoid redundancy.

Referring to FIG. 2, the TIM Broadcast Interval 1 field, the TIM Broadcast Interval 2 field, etc., may be examples of the TIM frame broadcast interval for each of the multi-links, and have similar set values to the TIM Broadcast Interval field in Table 1. The Link ID 1 field, the Link ID 2 field, etc., may be examples of link ID information of each of the multi-links. For example, each link ID (Link ID 1, Link ID 2, etc.) may have a plurality of bits to identify combination information on an operating spectrum, a bandwidth/channel, and a basis service set identifier (BSSID). However, examples of the link ID information are not limited to Link ID 1, Link ID 2 and other link IDs in Table 2. For example, the link ID information may be a Link set, where the Link set may have a plurality of bits, and each bit corresponds to the corresponding link among the multi-links. The plurality of TIM broadcast interval fields in Table 2 may correspond to corresponding bits in the Link set, respectively. In addition, the link ID information may also be omitted from Table 2. For example, in a case that the first information is to request the TIM frame broadcast intervals for all of the multi-links, a plurality of TIM broadcast interval fields may be carried in a specific order (e.g., in an order determined by a bandwidth of each link).

Continued to referring to FIG. 2, in step S220, the first message frame may be sent. For example, the first message frame may be sent in the first link. However, the present disclosure is not limited to this, and the first message frame may also be sent in any of the multi-links.

According to the communication method provided in the examples of the present disclosure, information on the TIM frame broadcast interval for a single link or for multi-links requested by the station supporting the multi-link communication may be carried in this single link.

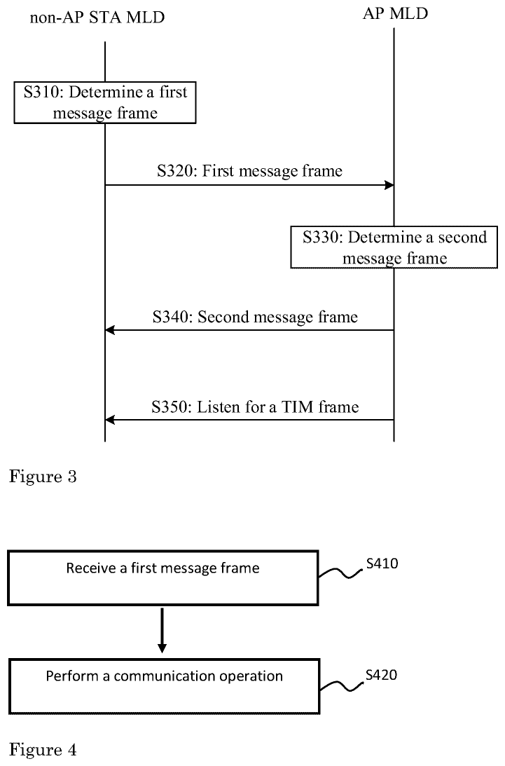

The communication method as shown in FIG. 2 is illustrative, and the present disclosure is not limited to this. For example, FIG. 3 is a flowchart illustrating an interactive communication according to an example of the present disclosure, and includes steps S310-S350.

Referring to FIG. 3, steps S310 and S320 may correspond to steps S210 and S220 in FIG. 2, and thus the descriptions with reference to FIG. 2, Table 1 and Table 2 may be cited herein. For the sake of brevity, repeated descriptions are omitted.

In step S340, the station may receive a second message frame from the access point (AP MLD). For example, a secondary STA of a non-AP STA MLD may receive the second message frame from corresponding secondary AP of the AP MLD in one link (first link). In the examples of the present disclosure, the second message frame may be determined (step S330) by the access point based on the first message frame transmitted in step S320. For example, the second message frame may include feedback information from the access point to the first information. As a descriptive example, the feedback information may be carried in the second message frame in the form of a TIM broadcast response element. For example, the second message frame may be a re-association response frame, an association response frame, a TIM broadcast response frame, etc.

For example, the feedback information may include status information indicating “accept” the first information, in a case where the access point accepts the first information. For another example, in a case where the access point rejects the first information, the feedback information may include second information on the TIM frame broadcast intervals related to the multi-links and recommended (or suggested or set) by the access point. In this case, the second information in the second message frame may have a corresponding format with the first information in the first message frame.

In an example of the present disclosure, the second information in the second message frame may include a recommended set value of the TIM frame broadcast interval for the first link, in a case where the first information in the first message frame includes the set value of the TIM frame broadcast interval for the first link.

For example, the second information may be included in the TIM broadcast response information element in a format as shown in Table 3 below.

TABLE 3
Format of TIM broadcast response information element

| | | | |
|---|---|---|---|
| Element ID | Length | Status | TIM Broadcast Interval |
| | | | (optional) |

In Table 3, the element ID field and the length field may identify a TIM broadcast response information element and a length, respectively. The status field may identify whether the access point accepts the first information carried in the first message frame. The TIM broadcast interval field may be omitted in a case that the status field indicates “Accept”. The TIM broadcast interval field may be further included in a case that the status field indicates “Reject”. For example, in a case where the first information indicates the TIM frame broadcast interval for the first link at the MLD level, the TIM broadcast interval field in the second message frame may identify the TIM frame broadcast interval for the first link and recommended by the access point. The set value of the TIM broadcast interval field in the second message frame may be similar to the set value of the TIM broadcast interval field in Table 1. For the sake of brevity, repeated descriptions are omitted.

In addition, it will be understood that the format described in Table 3 is illustrative, and the present disclosure is not limited to this. For example, the TIM broadcast response information elements may also include a TIM Broadcast Offset field, a High Rate TIM Rate field, and a Low Rate TIM Rate field. The TIM Broadcast Offset field may include a time offset of a Target Beacon Transmission Time (TBTT) relative to the time the TIM frame is sent, e.g., in a unit of milliseconds, and may have a tolerance of ±4 μs. The High Rate TIM Rate field may provide an indicator of a rate at which a high data rate TIM frame is sent. The Low Rate TIM Rate field provides an indicator of a rate at which a low data rate TIM frame is sent.

In another example of the present disclosure, the second information in the second message frame may include the recommended set value of the TIM frame broadcast interval for each of the multi-links, in a case where the first information in the first message frame includes the set value of the TIM frame broadcast interval for each of the multi-links. In addition, the second information may also include link ID information for identifying each of the multi-links. In this case, the TIM broadcast response information element as an example of the second information may have a format as shown in Table 4 below.

TABLE 4
Format of TIM broadcast response information element

| | | | | | | | |
|---|---|---|---|---|---|---|---|
| Element | Length | Status | TIM | Link ID 1 | TIM | Link ID 2 | . . . |
| ID | | | Broadcast | (optional) | Broadcast | (optional) | |
| | | | Interval 1 | | Interval 2 | | |
| | | | (optional) | | (optional) | | |

In Table 4, the element ID field and the length field may identify a TIM broadcast response information element and a length, respectively. The status field may identify whether the access point accepts the first information carried in the first message frame. Each TIM Broadcast Interval field and each Link ID field may be omitted in a case that the status field indicates “Accept”. TIM frame broadcast intervals for each of the multi-links, e.g., TIM Broadcast Interval 1 and TIM Broadcast Interval 2, may be further included, in a case that the Status field indicates “Reject”. In Table 4, “Link ID 1, Link ID 2” etc., may be examples of the link ID information on each of the multi-links. However, the present disclosure is not limited to this. The link ID information may be carried in the form of a Link set as described in Table 2.

In an example, the Status field may indicate to accept or reject the TIM frame broadcast intervals for all links and requested by the first information in the first message frame. In this case, Table 4 may include one Status field. However, in another example, Table 4 may include a plurality of Status fields, and each Status field may correspond to one of the multi-links to indicate whether to accept the TIM frame broadcast interval requested for corresponding link. In addition, similar to Table 3, the TIM broadcast response information element shown in Table 4 may also include a TIM Broadcast Offset field, a High Rate TIM Rate field, and a Low Rate TIM Rate field, which may be at an MLD level or link level.

According to an example of the present disclosure, the TIM broadcast request information element is at an MLD level. Specifically, in one link, a STA attached to a non-AP STA MLD carries the TIM broadcast request information element during the multi-link establishment process (e.g., an association request frame). The set value of the TIM broadcast interval in the TIM broadcast request information element is based on beacon frame cycles in this link. In a receiving link, an AP attached to the AP MLD replies in this link with, for example, an association response frame including fields such as status field to an STA attached to the non-AP STA MLD. In a case that the Status field is set to “Accept”, a TIM broadcast interval field is not included; and in a case that the status field is set to “Reject”, a TIM broadcast interval field is included. This example may be applied to a TIM broadcast request frame.

According to another example of the present disclosure, the TIM broadcast request information element is at a link level. Specifically, the TIM broadcast request frame (or, (re)association request frame) contains the TIM broadcast interval information element for each link, which corresponds to a Link ID. The TIM broadcast response frame (or, (re)association response frame) also contains the TIM broadcast interval information element for each link, which corresponds to a Link ID. The TIM broadcast interval information element also contains the Status field. In a case that the Status field indicates “Not Accept”, the TIM broadcast interval information element may contain a recommended TIM broadcast interval field. This example may be applied to a multi-link establishment process.

In FIG. 3, a non-AP STA MLD and an AP MLD may negotiate a TIM frame broadcast interval in, for example, the multi-link establishment process through steps S310 to S340, so that the non-AP STA MLD can listen for, e.g. monitor, the TIM frame according to the negotiated TIM frame broadcast interval (step S350), so as to obtain the changes of BSS parameter information to meet the requirements of the multi-link communication.

FIG. 4 is a flowchart illustrating a communication method according to an example of the present disclosure. The communication method shown in FIG. 4 may be performed by an access point (e.g., AP MLD) supporting multi-link communication, and includes steps S410 and S420.

Referring to FIG. 4, in step S410, a first message frame is received in a first link among multi-links. The first message frame may include first information on traffic indication map (TIM) frame broadcast intervals related to the multi-links and requested by a station, the station supporting the multi-link communication and associated with the access point. The multi-links refers to multi-links established between the station and the access point.

According to an example of the present disclosure, the first information may include a set value of the TIM frame broadcast interval for the first link. The TIM frame broadcast interval may indicate a number of beacon frame cycles between sending of TIM frames. The set value of the TIM frame broadcast interval for the first link is based on the beacon frame cycles in the first link.

According to an example of the present disclosure, a value of the TIM frame broadcast interval for another link other than the first link among the multi-links has a specific offset value from the set value of the TIM frame broadcast interval for the first link.

According to an example of the present disclosure, the first information may include the set value of the TIM frame broadcast interval for each of the multi-links.

According to an example of the present disclosure, the first information may include link ID information configured to identify each of the multi-links.

The first message frame and the first information in step S410 may be similar to that in the examples described with reference to FIG. 2, Table 1 and Table 2. For the sake of brevity, detailed descriptions are omitted.

In step S420, a communication operation is performed based on the first message frame. For example, it may be determined whether the first information in the first message frame is accepted, and steps S330 and S340 performed by an AP MLD with reference to FIG. 3 may be performed.

According to an example of the present disclosure, the access point may send a second message frame to the station. The second message frame includes feedback information from the access point to the first information.

According to an example of the present disclosure, the feedback information may include status information indicating “accept” the first information, in a case where the access point accepts the first information.

According to an example of the present disclosure, the feedback information may include second information on TIM frame broadcast intervals related to the multi-links and recommended by the access point, in a case where the access point rejects the first information.

According to an example of the present disclosure, the second information may include a recommended set value of the TIM frame broadcast interval for the first link, in a case where the first information includes the set value of the TIM frame broadcast interval for the first link.

According to an example of the present disclosure, the second information may include a recommended set value of the TIM frame broadcast interval for each of the multi-links, in a case where the first information includes the set value of the TIM frame broadcast interval for each of the multi-links.

According to an example of the present disclosure, the second information may also include link ID information configured to identify each of the multi-links.

The second message frame and the second information may be similar to that in the examples described with reference to FIG. 3, Table 3 and Table 4. For the sake of brevity, detailed descriptions are omitted.

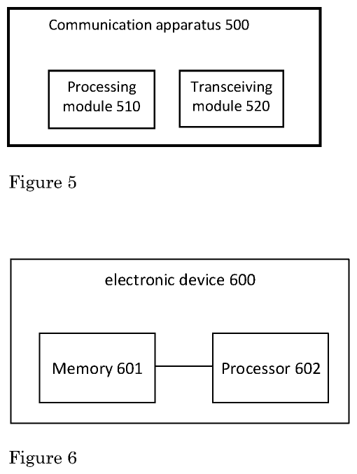

FIG. 5 is a block diagram illustrating a communication apparatus 500 according to an example of the present disclosure. Referring to FIG. 5, the communication apparatus 500 may include a processing module 510 and a transceiving module 520. The communication apparatus 500 shown in FIG. 5 may be applied to an AP MLD or a non-AP STA MLD.

In a case where the communication apparatus 500 shown in FIG. 5 is applied to a non-AP STA MLD, the processing module 510 may be configured to determine a first message frame in a first link among multi-links, the first message frame including first information on traffic indication map (TIM) frame broadcast intervals related to the multi-links and requested by a station, the multi-links referring to multi-links established between the station and an associated access point supporting multi-link communication. The transceiving module 520 may be configured to send the first message frame. In this case, the communication apparatus 500 may perform the communication method described with reference to FIG. 2 and operations performed by the non-AP STA MLD in FIG. 3. For the sake of brevity, repeated descriptions are omitted.

In a case where the communication apparatus 500 shown in FIG. 5 may be applied to an AP MLD, the transceiving module 520 may be configured to receive a first message frame in a first link among multi-links, the first message frame including first information on traffic indication map (TIM) frame broadcast intervals related to the multi-links and requested by a station, the station supporting multi-link communication and associated with an access point, the multi-links referring to multi-links established between the station and the access point. The processing module 510 may be configured to control execution of a communication operation based on the first message frame. In this case, the communication apparatus 500 may perform the communication method described with reference to FIG. 4 and operations performed by the AP MLD in FIG. 4. For the sake of brevity, repeated descriptions are omitted.

In addition, the communication apparatus 500 shown in FIG. 5 is illustrative, and the examples of the present disclosure are not limited to this. For example, the communication apparatus 500 may also include other modules, such as a memory module. Moreover, the individual modules in the communication apparatus 500 may be combined into more complex modules or may be divided into more individual modules. The individual modules can have any the structure of any known device capable of performing the function of said module. For example, the processing module 510, may be any type of processor.

The communication method and the communication apparatus according to the examples of the present disclosure may negotiate TIM frame broadcast intervals, so that a non-AP STA MLD can listen for TIM frames according to the negotiated TIM frame broadcast intervals, so as to obtain the changes of BSS parameter information to meet the requirements of the multi-link communication.

Based on the same principle as the method provided in the examples of the present disclosure, an example of the present disclosure further provides an electronic device 600 as shown in FIG. 6. The electronic device 600 includes one or more processors 602 and a memory 601. The memory 601 is configured to store machine-readable instructions (which may also be referred to as a “computer program”). The one or more processors 602 are collectively configured to execute the machine-readable instructions to implement the method described with reference to FIG. 2 to FIG. 4.

An example of the present disclosure further provides a non-transitory computer-readable storage medium configured to store a computer program. The computer program, when executed by one or more processors, causes the one or more processors to collectively implement the method described with reference to FIG. 2 to FIG. 4.

In an example, the one or more processors may be collectively configured to implement or execute various illustrative logic boxes, modules, and circuits described in conjunction with the present disclosure. The one or more processors may be a central processing unit (CPU), a universal processor, a digital signal processor (DSP), an application specific integrated circuit (ASIC), a programmable gate array (FPGA), or other programmable logic devices, transistor logic devices, hardware components, or any combinations of the above. The one or more processors may also be a combination that implements a computing function, such as a combination of one or more microprocessors, a combination of a DSP and a microprocessor, etc.

In an example, the memory may be, for example, a read-only memory (ROM), a random access memory (RAM), an electrically erasable programmable read only memory (EEPROM), a compact disc read only memory (CD-ROM) or other optical disc storage, optical disk storage (including a compact disk, a laser disk, an optical disk, a digital general disk, a Blu-ray disk, etc.), a magnetic disc storage medium or other magnetic storage devices, or any other medium which can be configured to carry or store program codes in the form of instructions or data structures and can be accessed by a computer, but is not limited this.

It needs to be understood that although the various steps in the flowchart of the accompanying drawings are sequentially displayed as indicated by arrows, these steps are not necessarily performed in the order indicated by the arrows. Except as explicitly stated, the execution of these steps is not strictly limited, and may be performed in other sequences. Moreover, at least some of the steps in the flowchart of the accompanying drawings may include a plurality of sub-steps or stages, which are not necessarily performed at the same time, but may be executed at different times. The execution order of these sub-steps or stages is also not necessarily performed sequentially, but may be performed in turn or alternately with at least a portion of other steps or sub-steps or stages of other steps.

Although the present disclosure has been shown and described with reference to some examples of the present disclosure, those skilled in the art will understand that various changes in form and detail may be made without departing from the scope of the present disclosure. The scope of the present disclosure shall not be limited to being restricted to examples of the present disclosure, but rather by the appended claims and their equivalents.

1. A communication method, performed by a station supporting multi-link communication, the communication method comprising:
determining a first message frame in a first link among multi-links, wherein the first message frame comprises: first information on traffic indication map (TIM) frame broadcast intervals related to the multi-links and requested by the station, and
wherein the multi-links refers to multi-links established between the station and an access point (AP), associated with the station, supporting the multi-link communication; and
sending the first message frame.

2. The communication method according to claim 1,
wherein the first information comprises a set value of the TIM frame broadcast interval for the first link,
wherein the TIM frame broadcast interval indicates a number of beacon frame cycles between sending of TIM frames, and
wherein the set value of the TIM frame broadcast interval for the first link is based on one of the beacon frame cycles in the first link.

3. The communication method according to claim 2, wherein a value of a TIM frame broadcast interval for another link other than the first link among the multi-links has a specific offset value from the set value of the TIM frame broadcast interval for the first link.

4. The communication method according to claim 1, wherein the first information comprises a set value of the TIM frame broadcast interval for each of the multi-links.

5. The communication method according to claim 4, wherein the first information further comprises link ID information configured to identify each of the multi-links.

6. The communication method according to claim 1, further comprising:
receiving a second message frame from the AP, wherein the second message frame comprises feedback information from the AP to the first information.

7. The communication method according to claim 6, wherein the feedback information comprises at least one of:
status information indicating an acceptance of the first information, in a case where the AP accepts the first information, or
second information on TIM frame broadcast intervals related to the multi-links and recommended by the AP, in a case where the AP rejects the first information.

8. (canceled)

9. The communication method according to claim 7, wherein the second information comprises at least one of:
a recommended set value of the TIM frame broadcast interval for the first link, in a case where the first information comprises the set value of the TIM frame broadcast interval for the first link, or
a recommended set value of the TIM frame broadcast interval for each of the multi-links, in a case where the first information comprises the set value of the TIM frame broadcast interval for each of the multi-links.

10. (canceled)

11. The communication method according to claim 9, wherein the second information further comprises link ID information configured to identify each of the multi-links.

12. A communication method, performed by an access point supporting multi-link communication, the communication method comprising:
receiving a first message frame in a first link among multi-links,
wherein the first message frame comprises first information on traffic indication map (TIM) frame broadcast intervals related to the multi-links and requested by a station, the station supporting the multi-link communication and associated with the access point, and
wherein the multi-links refers to multi-links established between the station and the access point; and
performing a communication operation based on the first message frame.

13. The communication method according to claim 12,
wherein the first information comprises a set value of the TIM frame broadcast interval for the first link,
wherein the TIM frame broadcast interval indicates a number of beacon frame cycles between sending of TIM frames, and
wherein the set value of the TIM frame broadcast interval for the first link is based on one of the beacon frame cycles in the first link.

14. The communication method according to claim 13, wherein a value of the TIM frame broadcast interval for another link other than the first link among the multi-links has a specific offset value from the set value of the TIM frame broadcast interval for the first link.

15. The communication method according to claim 12, wherein the first information comprises a set value of the TIM frame broadcast interval for each of the multi-links.

16. The communication method according to claim 15, wherein the first information further comprises link ID information configured to identify each of the multi-links.

17. The communication method according to claim 12, further comprising:
sending a second message frame to the station, wherein the second message frame comprises feedback information from the access point to the first information.

18. The communication method according to claim 17, wherein the feedback information comprises at least one of:
status information indicating an acceptance of the first information, in a case where the access point accepts the first information; or
second information on TIM frame broadcast intervals related to the multi-links and recommended by the access point, in a case where the access point rejects the first information.

19. (canceled)

20. The communication method according to claim 18, wherein the second information comprises at least one of:
a recommended set value of the TIM frame broadcast interval for the first link, in a case where the first information comprises the set value of the TIM frame broadcast interval for the first link, or
a recommended set value of the TIM frame broadcast interval for each of the multi-links, in a case where the first information comprises the set value of the TIM frame broadcast interval for each of the multi-links.

21. (canceled)

22. The communication method according to claim 20, wherein the second information further comprises link ID information configured to identify each of the multi-links.

23-24. (canceled)

25. An electronic device, comprising a memory, one or more processors, and a computer program stored in the memory and runnable on the one or more processors, wherein the computer program, when executed by the one or more processors, causes the one or more processors to collectively perform:
determining a first message frame in a first link among multi-links,
wherein the first message frame comprises first information on traffic indication map (TIM) frame broadcast intervals related to the multi-links and requested by the station, and
wherein the multi-links refers to multi-links established between the station and an access point, associated with the station, supporting the multi-link communication; and
sending the first message frame.

26. (canceled)

27. An electronic device, comprising a memory, one or more processors, and a computer program stored in the memory and runnable on the one or more processors, wherein the computer program, when executed by the one or more processors, causes the one or more processors to collectively perform the method according to claim 12.
